(19) United States
(12) Patent Application Publication
(10) Pub. No.: US 2025/0284700 A1
(43) Pub. Date: Sep. 11, 2025

(54) INFORMATION PROCESSING APPARATUS, THINKING SUPPORT METHOD, AND STORAGE MEDIUM

(71) Applicant: NEC Corporation, Tokyo (JP)

(72) Inventor: Shinji CHICHIBU, Tokyo (JP)

(73) Assignee: NEC Corporation, Tokyo (JP)

(21) Appl. No.: 19/064,871

(22) Filed: Feb. 27, 2025

(30) Foreign Application Priority Data
Mar. 5, 2024 (JP) 2024-033275

(51) Int. Cl. G06F 16/248; G06F 16/2457

(52) U.S. Cl. CPC G06F 16/248; G06F 16/2457

(57) ABSTRACT

To easily carry out efficient thinking using frameworks, an information processing apparatus includes: a reception section that receives an input of target-related information related to a target of thinking; and a generation control section that causes a generative model trained by performing machine learning to generate, using the target-related information, content to be inputted into a framework capable of being used in thinking about the target.

This Nonprovisional application claims priority under 35 U.S.C. § 119 on Patent Application No. 2024-033275 filed in Japan on Mar. 5, 2024, the entire contents of which are hereby incorporated by reference.

### TECHNICAL FIELD

The present disclosure relates to an information processing apparatus, a thinking support method, and a storage medium.

### BACKGROUND ART

Techniques for supporting efficient thinking are known. An example of a technique for supporting efficient thinking is a creation support method of a business model disclosed in Patent Literature 1. By using this creation support method, it is possible to output a third activity that can be implemented as operations of a third business model in which a first business model and a second business model are linked together. This allows a user to recognize the third activity that can be implemented as operations of the third business model, so that the user can quickly create the third business model, which is a new business.

### CITATION LIST

### Patent Literature

### [Patent Literature 1]

Japanese Patent Application Publication Tokukai No. 2019-204418

### SUMMARY OF INVENTION

### Technical Problem

It is also known that various types of frameworks are used as another means for supporting efficient thinking. Here, the frameworks means frameworks in carrying out various kinds of thinking such as decision making, analysis for solving problems, organization of thinking, and generation of ideas. The framework can also be expressed as a systematic summary of thinking procedures.

By using a framework in accordance with a target of thinking, it becomes possible to increase thinking efficiently. For example, a logic tree, which is a framework, involves hierarchically repeating the decomposition of problems to be solved or objects into their components. By using this framework, the whole image of the problem can be expressed in a tree form, so that the essence of the problem and the means for solving it can be easily found.

However, for those who are unfamiliar with such frameworks, there is a problem in that it is not easy to apply a target of thinking to the frameworks. The present disclosure has been made in view of this problem, and an example object thereof is to provide a technique for easily carrying out efficient thinking using a framework.

### Solution to Problem

An information processing apparatus in accordance with an example aspect of the present disclosure is an apparatus including at least one processor, the at least one processor carrying out: a reception process of receiving an input of target-related information related to a target of thinking; and a generation control process of causing a generative model trained by performing machine learning to generate, using the target-related information, content to be inputted into a framework capable of being used in thinking about the target.

A thinking support method in accordance with an example aspect of the present disclosure is a method including: a reception process of receiving an input of target-related information related to a target of thinking, the process being carried out by at least one processor; and a generation control process of causing a generative model trained by performing machine learning to generate, using the target-related information, content to be inputted into a framework capable of being used in thinking about the target, the process being carried out by the at least one processor.

A storage medium in accordance with an example aspect of the present disclosure is a computer-readable, non-transitory storage medium storing a thinking support program for causing a computer to function as: reception means for receiving an input of target-related information related to a target of thinking; and generation control means for causing a generative model trained by performing machine learning to generate, using the target-related information, content to be inputted into a framework capable of being used in thinking about the target.

### Advantageous Effects of Invention

According to an example aspect of the present disclosure, it is possible to achieve example advantage of being capable of providing a technique for easily carrying out efficient thinking using a framework.

### BRIEF DESCRIPTION OF DRAWINGS

FIG. 1 is a block diagram illustrating the configuration of an information processing apparatus in accordance with the present disclosure.

FIG. 2 is a flowchart illustrating the flow of a thinking support method in accordance with the present disclosure.

FIG. 3 is a diagram for describing the configuration of a thinking support system in accordance with the present disclosure.

FIG. 4 is a block diagram illustrating the configuration of another information processing apparatus in accordance with the present disclosure.

FIG. 5 is a diagram for describing a method of causing a generative model to generate content.

FIG. 6 is a flowchart illustrating the flow of a thinking support method in accordance with the present disclosure.

FIG. 7 is a block diagram illustrating the configuration of a computer that functions as the information processing apparatuses in accordance with the present disclosure.

### EXAMPLE EMBODIMENTS

Example embodiments of the present invention will be described below by way of example. It should be noted that the present invention is not limited to the example embodiments described below, but may be altered in various ways within the scope of the claims. For example, any example embodiment derived by appropriately combining techniques (part or the entirety of a product or method) employed in the example embodiments described below can be within the scope of the present invention. Further, any example embodiment derived from appropriately omitting some of the techniques employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment, which is an example of an embodiment of the present invention, will be described in detail with reference to the drawings. The present example embodiment is a basic form of each example embodiment discussed later. Note that the scope of an application of techniques employed in the present example embodiment is not limited to the present example embodiment. That is, each technique employed in the present example embodiment can be employed also in another example embodiment included in the present disclosure, provided that no particular technical problems occur. In addition, each technique indicated in the drawings referred to for discussing the present example embodiment can be employed also in another example embodiment included in the present disclosure, provided that no particular technical problems occur.

### (Configuration of Information Processing Apparatus 1)

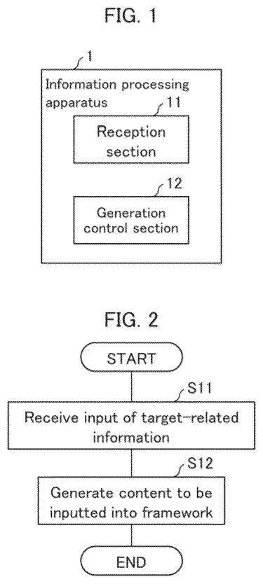

The following description will discuss the configuration of an information processing apparatus 1 in accordance with the present example embodiment with reference to FIG. 1. FIG. 1 is a block diagram illustrating the configuration of the information processing apparatus 1. As illustrated in FIG. 1, the information processing apparatus 1 includes a reception section 11 and a generation control section 12.

The reception section 11 receives an input of target-related information related to a target of thinking. Note that any matter may be employed as the target of thinking. Examples of the target of thinking may include, for example, matters subjected to decision making, matters to be analyzed, issues to be addressed for the solution, and themes for use in generating ideas.

The target-related information may be any information that is related to the target of thinking. For example, the target-related information may be material describing matters subjected to decision making, matters to be analyzed, issues to be addressed for the solution, and themes for use in generating ideas. The target-related information may be data in a text format or data in another format such as image data, or may include data in multiple formats.

The generation control section 12 causes a generative model trained by performing machine learning to generate, using the target-related information which has been received as input by the reception section 11, content to be inputted into a framework capable of being used in thinking about the abovementioned target. Here, as described in the item “Solution to Problem” above, the framework means a framework in carrying out various kinds of thinking such as decision making, analysis for solving problems, organization of thinking, and generation of ideas. The framework can also be expressed as a systematic summary of thinking procedures. For example, examples of the framework may include user story mapping described later, customer journey, logic tree, value chain, mandala chart, and Osborn's checklist.

The generative model may be any model that has been subjected to machine learning to generate content that corresponds to the target-related information and is configured to be inputted into the framework. For example, in a case where the target-related information is text data of a natural language, a language model trained with use of the natural language may be used as the generative model. Further, for example, in a case where the target-related information is image data, a language model trained to generate content from image data may be used as the generative model. The reception section 11 may convert data inputted in a format other than text into the text format and use the converted data as the target-related information. In this case, content based on data inputted in various formats can be generated by a single language model. Note that various generative models can also be used to perform format conversion of data.

The generative model may be a general-purpose model applicable to other applications, or may be a model specialized in generating content to be inputted into the framework. The generative model may be obtained by subjecting the general-purpose model to fine-tuning so that the model can appropriately generate content inputted into the framework. The generative model may be provided in the information processing apparatus 1 or may be provided in another apparatus. In the latter case, the generation control section 12 instructs the another apparatus provided with the generative model to generate content. A combination of two or more generative models may be used to generate content. The generative model may be a model referred to as so-called generative artificial intelligence (AI). As described in the foregoing, the information processing apparatus 1 in accordance with the present example embodiment employs a configuration in which the apparatus includes: the reception section 11 that receives an input of target-related information related to a target of thinking; and the generation control section 12 that causes a generative model trained by performing machine learning to generate, using the target-related information, content to be inputted into a framework capable of being used in thinking about the target.

Thus, according to the information processing apparatus 1, it is possible achieve an example advantage of being capable of easily carrying out efficient thinking using the framework. Further, according to the information processing apparatus 1, it is also possible to support the user's decision-making. The information processing apparatus 1 can also be used in healthcare applications. In this case, it is sufficient to input various kinds of information related to the health of the user as the target-related information. For example, it is possible to have the user to input an actual value, a target value, or the like of his/her weight into the information processing apparatus 1 as the target-related information, to generate the content to be inputted into the framework for examining actions to be carried out in order to make the weight equal to or less than the target value.

### (Thinking Support Program)

The foregoing functions of information the processing apparatus 1 may be implemented by a program. A thinking support program in accordance with the present example embodiment causes a computer to function as: reception means for receiving an input of target-related information related to a target of thinking; and generation control means for causing a generative model trained by performing machine learning to generate, using the target-related information which has been received as input by the reception means, content to be inputted into a framework capable of being used in thinking about the target. According to this thinking support program, it is possible to easily carry out efficient thinking using the framework.

### (Flow of Thinking Support Method)

The following description will discuss the flow of a thinking support method in accordance with the present example embodiment with reference to FIG. 2. FIG. 2 is a flowchart illustrating the flow of the thinking support method. Note that steps of the thinking support method may be carried out by a processor of the information processing apparatus 1 or by a processor of another apparatus. Alternatively, the steps may be carried out by processors provided in respective different apparatuses.

In S11, at least one processor receives an input of target-related information related to a target of thinking.

In S12, the at least one processor causes a generative model trained by performing machine learning to generate, using the target-related information inputted in S11, content to be inputted into a framework capable of being used in thinking about the target.

As described in the foregoing, the thinking support method in accordance with the present example embodiment employs a configuration in which the method includes: a process of receiving an input of target-related information related to a target of thinking, the process being carried out by at least one processor; and a process of causing a generative model trained by performing machine learning to generate, using the inputted target-related information, content to be inputted into a framework capable of being used in thinking about the target, the process being carried out by the at least one processor. Therefore, according to the thinking support method in accordance with the present example embodiment, it is possible to easily carry out efficient thinking using the framework.

### Second Example Embodiment

A second example embodiment, which is an example of the embodiment of the present invention, will be described in detail with reference to the drawings. Note that the scope of an application of techniques employed in the present example embodiment is not limited to the present example embodiment. That is, each technique employed in the present example embodiment can be employed also in another example embodiment included in the present disclosure, provided that no particular technical problems occur. In addition, each technique illustrated in each drawing referred to for discussing the present example embodiment can be employed also in another example embodiment included in the present disclosure, provided that no particular technical problems occur.

### (Outline of Thinking Support System)

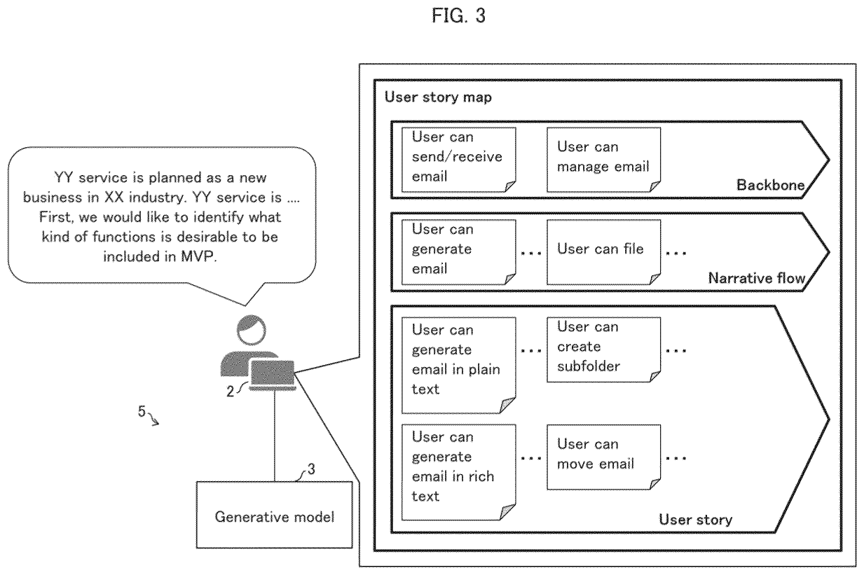

The following description will discuss the outline of a thinking support system in accordance with the present example embodiment with reference to FIG. 3. FIG. 3 is a diagram for describing the outline of the thinking support system. A thinking support system 5 illustrated in FIG. 3 is a system configured to support a user to think efficiently, and includes an information processing apparatus 2 and a generative model 3. The generative model 3 may be stored in the information processing apparatus 2 or may be stored in another apparatus (not illustrated).

The information processing apparatus 2 includes a function of automatically generating, based on information inputted by the user, content to be inputted into a framework that is useful for the user to think efficiently. Note that the information inputted by the user is information related to the target of thinking and is the target-related information described in the first example embodiment.

The generative model 3 is a model that has been trained by performing machine learning so as to be able to generate content that corresponds to information inputted by the user and is configured to be inputted into the framework. In the present example embodiment, an example in which the generative model 3 is a language model subjected to machine learning of the arrangement of components (words, etc.) in a sentence or the arrangement of sentences in a text will be described. By using the generative model 3, which is a language model, content in a text format can be generated from the target-related information in the text format. As the generative model 3, any model that is suitable for the format of the target-related information to be inputted and content to be outputted may be used, and the generative model 3 is not limited to the language model. For example, to generate image content, a generative AI trained to generate images may be adopted as the generative model 3.

In the example of FIG. 3, the user of the thinking support system 5 inputs a text describing a matter, which is the target of thinking, into the information processing apparatus 2 as the target-related information. The target of thinking in the example of FIG. 3 is “YY service”, which is planned as a new business. More specifically, the target of thinking is a function to be incorporated into the minimum viable product (MVP) of this service. Note that this text may be inputted with voice via a microphone or the like (not illustrated) or may be inputted by means of text inputted via an input device such as a keyboard (not illustrated). Upon receiving the abovementioned text as the target-related information, the information processing apparatus 2 determines a framework based on the target-related information, and causes the generative model 3 to generate content to be inputted into the determined framework. The information processing apparatus 2 presents, to the user, the framework with the generated content inputted.

In the example of FIG. 3, a framework called “user story map” is presented to the user. This framework is for use in planning a new service. This framework shows actions of a user who uses the service on a time-series basis as a story, and maps functions necessary for realizing the story.

In the illustrated example, three flows, that is, “backbone”, “narrative flow”, and “user story” are arranged in parallel. Of these, the backbone lists core actions and needs of a user who uses the new service in chronological order. The narrative flow lists the outline of functions corresponding to the actions and needs described in the backbone. The user story lists the details of the functions described in the narrative flow. Here, the higher the priority, the upper the function is displayed in the user story. Each piece of content inputted into the framework is generated by the generative model 3 as described above.

Thus, the user of the thinking support system 5 can efficiently examine which function is preferably incorporated into the MVP of the YY service planned by the user with reference to the priority of each function shown in the user story, and the backbone and the narrative flow corresponding to the function.

### (Configuration of Information Processing Apparatus 2)

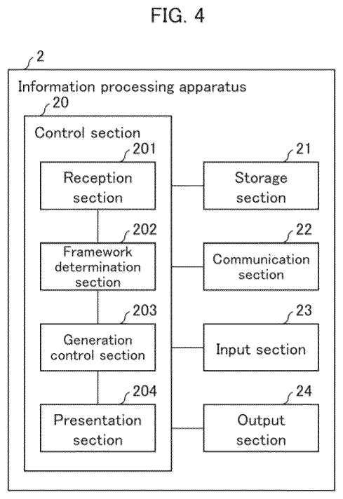

The following description will discuss the configuration of an information processing apparatus 2 in accordance with the present example embodiment with reference to FIG. 4. FIG. 4 is a block diagram illustrating the configuration of the information 15 processing apparatus 2. The information processing apparatus 2 is an apparatus configured to support a user to think efficiently. Note that the information processing apparatus 2 may be an apparatus in which the major function is thinking support, or a general-purpose apparatus in which other functions are also provided. The information processing apparatus 2 may be a stationary apparatus or a portable apparatus.

As illustrated in the figure, the information processing apparatus 2 includes: a control section 20 that centrally controls each section of the information processing apparatus 2; and a storage section 21 that stores various kinds of data used by the information processing apparatus 2. The information processing apparatus 2 also includes: a communication section 22 configured to allow communication between the information processing apparatus 2 and other apparatuses; an input section 23 that receives an input to the information processing apparatus 2; and an output section 24 via which the information processing apparatus 2 outputs data. The control section 20 includes a reception section 201, a framework determination section 202, a generation control section 203, and a presentation section 204.

The reception section 201 receives, similarly to the reception section 11 of the first example embodiment, an input of target-related information related to a target of thinking. Specifically, the reception section 201 obtains, as the target-related information, text data describing the target of thinking. As described above, the target-related information may be inputted as voice data. In this case, the reception section 201 may convert the inputted voice data into text data.

The framework determination section 202 determines a framework in accordance with the target-related information. Then, the generation control section 203 have content generated, the content being to be inputted into the framework determined by the framework determination section 202. Thus, in addition to the example advantage achieved by the information processing apparatus 1, it is possible to achieve an example advantage of enabling a user who has a dearth of knowledge about the framework to get along without conducting difficult work, that is, determining what kind of framework the user adopt.

For example, the framework determination section 202 may generate a prompt for instructing to provide one or more candidates for the framework in accordance with the target-related information, and present, to the user of the information processing apparatus 2, the one or more candidates provided in response to the input of the prompt into a trained language model. Note that the language model for generating the candidates for the framework may be the generative model 3 or may be another model. The candidates may be presented to the user via the presentation section 204. How the candidates are presented is not particularly limited. For example, the framework determination section 202 may present the candidates by causing a display device to output them by displaying, or may present the candidates by causing a sound output device to output them with voice.

Then, the framework determination section 202 may determine a candidate for the framework selected by the user from among the presented candidates for frameworks as the framework in accordance with the target-related information. Thus, in addition to the example advantage achieved by the information processing apparatus 1, it is possible to achieve an example advantage of being capable of making it easier for the user to select a desired framework. The selection by the user may be received via the input section 23 or the communication section 22.

Note that the framework determination section 202 is not an essential component. In a case where the framework determination section 202 is omitted, what framework will be used may be determined in advance, or alternatively, the user may specifies a framework.

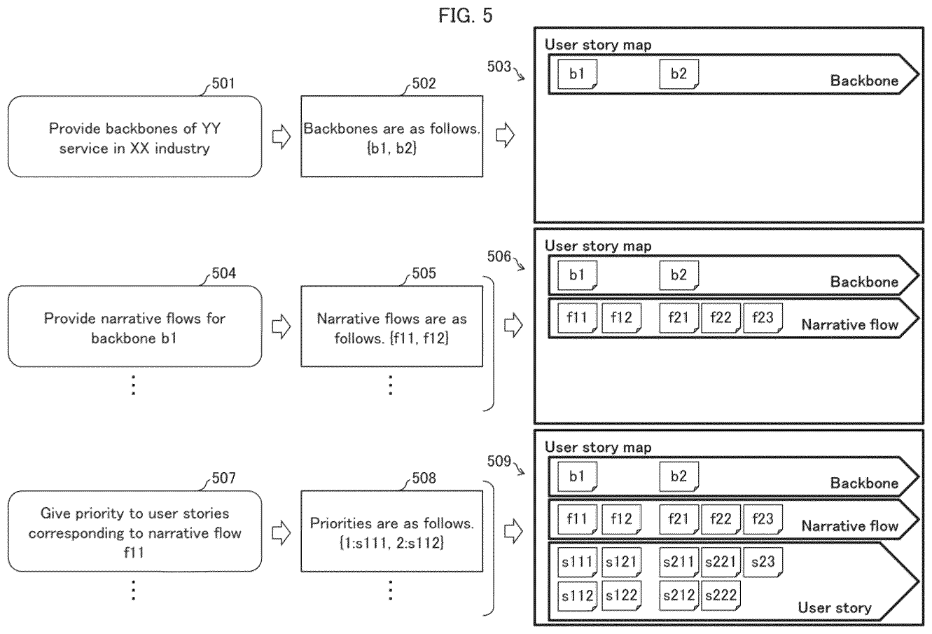

Similar to the generation control section 12 of the first example embodiment, the generation control section 203 causes the generative model 3 to generate, using the target-related information, content to be inputted into a framework capable of being used in thinking about the target. Details of the method of having the content generated will be described later with reference to FIG. 5.

The presentation section 204 presents the framework into which the content generated by the generative model 3 is inputted. Thus, in addition to the example advantage achieved by the information processing apparatus 1, it is possible to achieve an example advantage of allowing the user to quickly start thinking based on the presented framework. Here, how the candidates are presented is not particularly limited. For example, the presentation section 204 may output the framework with the content inputted by displaying it on the display device, or alternatively, the presentation section 204 may present the framework with the content inputted by causing a printing device to print out the framework. The output devices, such as the display device and the printing device, may be provided in the information processing apparatus 2, or may be devices external to the information processing apparatus 2. Note that the framework with the content inputted does not necessarily need to be immediately presented to the user; the framework with the content inputted may be stored in the storage section 21 or a storage device external to the information processing apparatus 2, and then presented as requested by the user.

It is preferable that the presentation section 204 present, as an image, the framework with the content inputted. The method of generating the image of the framework is not particularly limited. For example, the presentation section 204 may place each piece of content generated by the generation control section 203 on the image of a blank sheet of the framework with no contents inputted, to generate an image of the framework with the content inputted. The image of the blank sheet of the framework may be prepared in advance or may be generated by a generative model trained with images of frameworks.

The generation control section 203 may generate content in a text format that is capable of being opened with a predetermined software to display an image, that is, source code interpretable by this software. In this case, the presentation section 204 only needs to transmit the content to a terminal device used by the user, and the user can browse the image of the framework by opening the content with the predetermined software. The generation control section 203 may generate content in a specific file format that can be browsed by a specific software.

The presentation section 204 may present the framework with the content inputted in a presentation mode that is in accordance with the attribute of a presentation subject to whom the framework is presented (e.g., the user of the thinking support system 5). Thus, in addition to the example advantage achieved by the information processing apparatus 1, it is possible to achieve an example advantage of being capable of realizing the presentation in an appropriate mode, considering the attribute of the presentation subject.

This attribute only needs to be any feature or property of the presentation subject that is required to be considered or is preferable to be considered in determining the presentation mode. For example, the presentation section 204 may present the framework described above in a presentation mode that is in accordance with at least one of the age of the presentation subject, the level of familiarity with frameworks of the presentation subject, the language the presentation subject uses, and the like.

What kind of presentation mode will be adopted for a presentation subject of what kind of attribute may be determined in advance. For example, if the age of the presentation subject is not less than a predetermined threshold, the presentation section 204 may increase the size of characters included in the presented framework, or alternatively, for a subject who has] discrimination between certain colors, the framework may be presented without using these colors.

Further, for example, if the presentation subject is a learner who is learning how to use frameworks, the presentation section 204 may present a framework with a piece of the content to be inputted into the framework hidden, to allow the learner to think what is the hidden piece of the content. Then, the presentation section 204 may present the piece of the content thought by the learner and the hidden piece of the content in association with each other, to encourage the learner to conduct study by comparing them. Further, for example, if the text included in the generated content is written in a language different from the language the presentation subject uses, the presentation section 204 may translate the text into language of the presentation subject and present the translated text. Here, the translation may be carried out by the generative model 3, or may be carried out by another means such as a translation software.

It is also possible to have content generated in consideration of the attribute of the presentation subject. In this case, the presentation section 204 can carry out the presentation in a presentation mode that is in accordance with the attribute of the presentation subject only by presenting the content generated by the generative model 3 as it is. For example, if the presentation subject has low familiarity, the generation control section 203 may cause the generative model 3 to generate content for a person with low familiarity (e.g., content in which technical terms are annotated, or content supplemented with the reason, basis, or the like for generation of the content). Details of the method of causing the generative model 3 to generate content will be described later.

As described in the foregoing, the information processing apparatus 2 in accordance with the present example embodiment employs a configuration in which the apparatus includes: the reception section 201 that receives an input of target-related information related to a target of thinking; and the generation control section 203 that causes the generative model 3 to generate, using the target-related information, content to be inputted into a framework capable of being used in thinking about the target. Thus, according to the information processing apparatus 2, it is possible to achieve an example advantage of easily carrying out efficient thinking using the framework.

### (Method of Having Content Generated)

The following description will discuss a method of causing, by the generation control section 203, the generative model 3 to generate content with reference to FIG. 5. FIG. 5 is a diagram for describing the method of causing the generative model 3 to generate content. It is assumed that the inputted target-related information is a text (describing the YY service to be examined) illustrated in FIG. 3. In addition, it is assumed that the framework determination section 202 determines to use the user story map.

The generation control section 203 may generate, using the target-related information, a prompt for instructing the generative model 3 to generate content, and input the generated prompt into the generative model 3, to cause the generative model 3 to generate the content. Thus, it is possible to have content generated in accordance with the target-related information.

For example, to generate content to be inputted into the user story map, the generation control section 203 may generate a prompt 501 illustrated in FIG. 5. The prompt 501 is a text as follows: “provide backbones of YY service in XX industry”. The generation control section 203 can extract words “XX industry” and “YY service” included in the prompt 501 from the target-related information inputted by the user. The generation control section 203 may extract keywords to be included in the prompt 501 by means of morphological analysis or the like, or alternatively, the generation control section 203 can generate a prompt for instructing to extract keywords, to cause a language model (which may be the generative model 3, or may be another model) to extract the keywords.

The generation control section 203 may include a statement that indicates an attribute of the user in a prompt for generating content. Thus, it is possible to generate content in accordance with the user attribute. For example, by adding a statement “the presentation subject has a low familiarity with frameworks” in the prompt 501, the generation control section 203 can generate content for a person with low familiarity. The generation control section 203 may add, to the prompt 501, a statement for instructing to “put an annotation on each technical term”, if the presentation subject has low familiarity. Thus, it is possible to generate content in which technical terms are annotated.

The “backbone” is an essential item in generating a user story map. Thus, the generation control section 203 can generate the prompt 501 for requesting to provide the backbone based on the fact that the framework to be used is the user story mapping.

Note that items required in each framework may be determined in advance. The generation control section 203 may identify the items in each framework by using a language model (which may be the generative model 3 or another model). Thus, only by using a language model trained with the latest information related to the framework, content reflecting such latest information can be generated without modifying the information processing apparatus 2. For example, the generation control section 203 may generate a prompt for inquiring about essential items in generating the framework to be used, like “provide essential items in generating a user story map”, and input the prompt into the generative model 3. This allows the generation control section 203 to identify essential items in generating the framework, and to generate a prompt for identified items.

FIG. 5 illustrates a text 502 generated in response to the input of the prompt 501 into the generative model 3. The text 502 indicates that the backbones are “b1” and “b2”. Sections to which “b1” and “b2” are assigned are content to be inputted into the framework. Actually, each of the “b1” and “b2” sections includes a text such as “the user can send an email”, generated by the generative model 3.

Since the presentation section 204 uses the pieces of content, “b1” and “b2”, generated in this way, it possible to present a framework 503 into which the pieces of content, and “b2”, indicating the backbones are inputted into respective areas for indicating the backbones.

The presentation section 204 may present the framework 503 in such an uncompleted state (in a state in which some essential items are left blank in the framework). In this case, the generation control section 203 may receive feedback on the presented framework 503 from the user and reflect the received feedback in the subsequent content generation control. For example, in a case where the user instructs to modify the backbone “b1” to “b1′”, the generation control section 203 uses “b1′” in place of the backbone “b1” in the subsequent processing. The presentation section 204 changes the backbone to be presented from “b1” to “b1′”.

In a case where the pieces of content indicating the backbone, “b1” and “b2”, are generated, the generation control section 203 generates a prompt for instructing generation of content that indicates items of the framework related to the pieces of content indicating the backbone. In the example of FIG. 5, the generation control section 203 generates a prompt 504 for requesting to provide a narrative flow for “b1”. FIG. 5 illustrates a text 505 generated in

response to the input of the prompt 504 into the generative model 3. The text 505 indicates that the narrative flows for the backbone “b1” are “f11” and “f12”. Sections to which “f11” and “f12” are assigned are pieces of content to be inputted into the framework. Each of the “f11” and “f12” sections actually includes a text generated by the generative model 3 such as “user can generate email”.

Similarly, in the case of “b2”, the generation control section 203 generates a prompt for requesting the generative model 3 to provide a narrative flow, and inputs the generated prompt into the generative model 3. This allows the generative model 3 to generate pieces of content (f21, f22, f23) each indicating a narrative flow corresponding to “b2”.

Since the presentation section 204 uses the pieces of content, “f11”, “f12”, “f21”, “f22”, and “f23”, generated in this way, it is possible to present a framework 506 into which the pieces of content, “f11”, “f12”, “f21”, “f22”, and “f23”, indicating the narrative flows are inputted into respective areas for indicating the narrative flows for the corresponding backbones.

In a case where the pieces of content indicating the narrative flows are generated, the generation control section 203 generates a prompt for instructing generation of content that indicates items of the framework related to the pieces of content indicating the narrative flows. In the example of FIG. 5, the generation control section 203 generates a prompt 507 for requesting to give priority to the user stories for “f11”.

FIG. 5 illustrates a text 508 generated in response to the input of the prompt p 507 into the generative model 3. The text 508 indicates that, among the user stories corresponding to the narrative flow “f11”, a user story ranked in the first place is “s111” and a user story ranked in the second place is “s112”. Sections to which “s111” and “s112” are assigned are pieces of content to be inputted into the framework. Each of the “s111” and “s112” sections actually includes a text generated by the generative model 3 such as “user can generate email in plain text”.

The same applies to other narrative flows, such as “f12” and “f21”. That is, the generation control section 203 generates a prompt for requesting to give priority to the user stories and inputs the generated prompt into the generative model 3. This allows the generative model 3 to generate pieces of content each indicating a user story for corresponding narrative flow.

Since the presentation section 204 uses the pieces of content indicating the user stories generated in this way, it is possible to present a framework 509 into which the pieces of content indicating the user stories are inputted into respective areas for indicating the user stories for the corresponding narrative flows. This also enable the presentation section 204 to present the user stories for corresponding narrative flows in order of priority.

### (Flow of Processing)

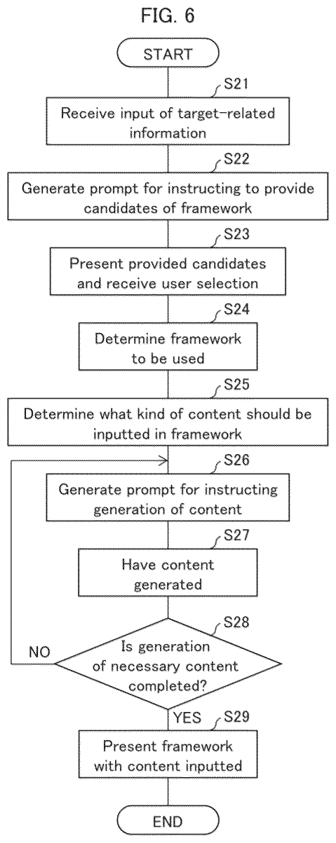

The following description will discuss the flow of processing carried out by the information processing apparatus 2 with reference to FIG. 6. FIG. 6 is a flowchart illustrating the flow of the processing carried out by the information processing apparatus 2. The flow of FIG. 6 includes steps of the thinking support method in accordance with the present example embodiment.

In S21 (reception process), the reception section 201 receives an input of target-related information related to a target of thinking. For example, the reception section 201 may receive, as the target-related information, text data that describes the target of thinking and is inputted via the input section 23. The reception section 201 may also receive an input of attribute information indicating the attribute of a presentation subject to whom the framework is presented. Thus, it is possible to present the framework in a presentation mode that is in accordance with the attribute.

In S22, the framework determination section 202 generates a prompt for instructing to provide one or more candidates for the framework. The framework determination section 202 inputs the generated prompt into the language model and obtains one or more candidates of the framework.

In S23, the framework determination section 202 presents the one or more candidates obtained as described in the foregoing, and receives the user's selection. In S24, the framework determination section 202 determines a candidate selected by the user as the framework to be used.

In S25, the generation control section 203 determines what kind of content should be inputted into the framework determined in S24. For example, the generation control section 203 may generate a prompt for inquiring about items of the framework determined in S24, and input the generated prompt into the language model. Accordingly, the generation control section 203 can determine the items outputted by the language model as the content to be inputted into the framework. In addition, in a case where the description order of items in the framework is determined in advance (e.g., in a case where it is determined in advance that after a certain item, a particular item should be described as a premise of the certain item), the generation control section 203 may also ask a language model about the description order of the items.

In S26, the generation control section 203 generates a prompt for instructing the generative model 3 to generate content, using the target-related information obtained in S21. Here, what is instructed to generate is the content determined in S25. For example, in a case where it is determined to input the content indicating the backbone in the user story map into the framework in S25, the generation control section 203 generates a prompt for instructing generation of the content indicating the backbone. In S26, the generation control section 203 may extract words related to generation of the content from the target-related information and include them in the prompt, or may include the target-related information in the prompt as is.

In S27 (generation control process), the generation control section 203 causes the generative model 3 to generate the content to be inputted into the framework determined in S24. More specifically, the generation control section 203 causes the generative model 3 to generate the content by inputting the prompt generated in S26 into the generative model 3.

In S28, the generation control section 203 determines whether or not generation has been completed for all pieces of the content to be inputted into the framework determined in S25. If it is determined to be NO in S28, the process returns to S26. In S26 to which the processing proceeds from S28, the generation control section 203 generates a prompt for instructing generation of a piece of the content that has not been generated at that time from among the pieces of the content determined in S25. On the other hand, if it is determined to be YES in S28, the processing proceeds to S29.

In S29, the presentation section 204 presents the framework into which the pieces of content generated in the process of S27 are inputted. This terminates the processing illustrated in the figure.

Here, there may be a case where the target-related information inputted by the user does not include pieces of content necessary for generating content to be inputted into the framework. In such a case, the generation control section 203 may cause the language model (which may be the generative model 3 or may be another model) to generate a message prompting the user to input additional information. Then, the presentation section 204 may present the generated message to the user, to prompt the user to input additional information.

For example, the generation control section 203 may input, into a language model, the target-related information that has been inputted in S21, and input, into a language model, a prompt “provide any insufficient information for generating a framework (determined in S24) “. This enables the generation control section 203 to identify information necessary to be inputted by the user in response to the prompting.

### [Variations]

Any subject may carry out each process described in the foregoing example embodiments, and is not limited to the examples described above. For example, it is possible to construct a system having the same functions as those of the information processing apparatuses 1, 2 with use of a plurality of apparatuses capable of mutual communication. The each process illustrated in the flowchart of FIG. 6 may be carried out by a single apparatus (in other words, a processor) or a plurality of apparatuses (in other words, processors).

### Software Implementation Example

Some or all of the functions of the information processing apparatuses 1 and 2 may be implemented by hardware such as an integrated circuit (IC chip), or may be alternatively implemented by software.

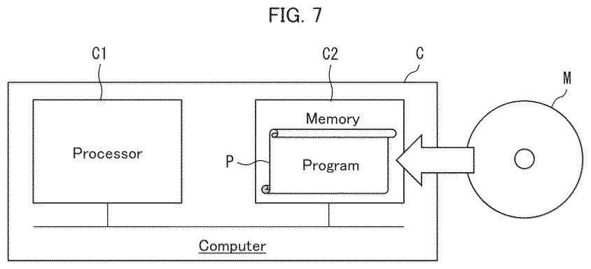

In the latter case, each of the information processing apparatuses 1 and 2 is implemented by, for example, a computer that executes instructions of a program that is software implementing the foregoing functions. FIG. 7 illustrates an example of such a computer (hereinafter, referred to as “computer C”). FIG. 7 is a block diagram illustrating the hardware configuration of the computer C that functions as the information processing apparatus 1 or 2.

The computer C includes at least one processor C1 and at least one memory C2. The memory C2 stores a program (thinking support program) P for causing the computer C to operate as the information processing apparatus 1 or 2. The processor C1 of the computer C retrieves the program P from the memory C2 and executes the program P, so that the functions of the information processing apparatus 1 or 2 are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds f data are temporarily stored. The computer C may further include a communication interface via which data is transmitted to and received from another apparatus. The computer C may further include an input-output interface for connecting input-output apparatuses such as a keyboard, a mouse, a display and a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

Each of the abovementioned functions of the information processing apparatuses 1 and 2 may be implemented by a single processor provided in a single computer, or by a plurality of processors provided in a single computer and operating in cooperation, or alternatively by a plurality of processors provided in each of the plurality of computers and operating in cooperation. Further, the program for causing the information processing apparatuses 1 and 2 to implement the abovementioned functions may be stored in a single memory provided in a single computer, or in a plurality of memories provided in a single computer in a distributed manner, or alternatively, in a plurality of memories provided in each of the plurality of computers in a distributed manner.

### [Additional Remark]

The present disclosure includes techniques described in supplementary notes below. Note, however, that the present invention is not limited to the techniques described in supplementary notes below, but may be altered in various ways within the scope of the claims.

### [Additional Remark A]

### (Supplementary Note A1)

An information processing apparatus including: reception means for receiving an input of target-related information related to a target of thinking; and generation control means for causing a generative model trained by performing machine learning to generate, using the target-related information, content to be inputted into a framework capable of being used in thinking about the target.

### (Supplementary Note A2)

The information processing apparatus according to Supplementary note A1, further including presentation means for presenting the framework with the generated content inputted.

### (Supplementary Note A3)

The information processing apparatus according to Supplementary note A1 or A2, further including framework determination means for determining the framework in accordance with the target-related information, wherein the generation control means causes the generative model to generate content to be inputted into the framework determined by the framework determination means.

### (Supplementary Note A4)

The information processing apparatus according to Supplementary note A3, wherein the framework determination means generates a prompt for instructing to provide one or more candidates for the framework in accordance with the target-related information, presents, to a user of the information processing apparatus, the one or more candidates provided in response to the input of the prompt into a trained language model, and determines a candidate for the framework selected by the user from among the presented candidates for the framework as the framework in accordance with the target-related information.

### (Supplementary Note A5)

The information processing apparatus according to Supplementary note A2, wherein the presentation means presents the framework with the content inputted in a presentation mode that is in accordance with an attribute of a subject to whom the framework is presented.

### (Supplementary Note A6)

The information processing apparatus according to any one of Supplementary notes A1 to A5, wherein the generation control means generates, using the target-related information, a prompt for instructing the generative model to generate content, and inputs the prompt into the generative model, to cause the generative model to generate the content.

### [Additional Remark B]

### (Supplementary Note B1)

A thinking support method including: a reception process of receiving an input of target-related information related to a target of thinking, the process being carried out by at least one processor; and a generation control process of causing a generative model trained by performing machine learning to generate, using the target-related information, content to be inputted into a framework capable of being used in thinking about the target, the process being carried out by the at least one processor.

### (Supplementary Note B2)

The thinking support method according to Supplementary note B1, further including a presentation process of presenting the framework with the generated content inputted, the process being carried out by the at least one processor.

### (Supplementary Note B3)

The thinking support method according to Supplementary note B1 or B2, wherein the at least one processor carries out a framework determination process of determining the framework in accordance with the target-related information, and in the generation control process, the at least one processor causes the generative model to generate content to be inputted into the framework determined in the framework determination process.

### (Supplementary Note B4)

The thinking support method according to Supplementary note B3, wherein in the framework determination process, the at least one processor generates a prompt for instructing to provide one or more candidates for the framework in accordance with the target-related information, presents, to a user of the information processing apparatus, the one or more candidates provided in response to the input of the prompt into a trained language model, and determines a candidate for the framework selected by the user from among the presented candidates for the framework as the framework in accordance with the target-related information.

### (Supplementary Note B5)

The thinking support method according to Supplementary note B2, wherein in the presentation process, the at least one processor presents the framework with the content inputted in a presentation mode that is in accordance with an attribute of a subject to whom the framework is presented.

### (Supplementary Note B6)

The thinking support method according to any one of Supplementary notes B1 to B5, wherein in the generation control process, the at least one processor generates, using the target-related information, a prompt for instructing the generative model to generate content, and inputs the prompt into the generative model, to cause the generative model to generate the content.

### [Additional Remark C]

### (Supplementary Note C1)

A thinking support program for causing a computer to function as: reception means for receiving an input of target-related information related to a target of thinking; and generation control means for causing a generative model trained by performing machine learning to generate, using the target-related information, content to be inputted into a framework capable of being used in thinking about the target.

### (Supplementary Note C2)

The thinking support program according to Supplementary note C1, causing the computer to function as presentation means for presenting the framework with the generated content inputted.

### (Supplementary Note C3)

The thinking support program according to Supplementary note C1 or C2, causing the computer to function as framework determination means for determining the framework in accordance with the target-related information, wherein the generation control means causes the generative model to generate content to be inputted into the framework determined by the framework determination means.

### (Supplementary Note C4)

The thinking support program according to Supplementary note C3, wherein the framework determination means generates a prompt for instructing to provide one or more candidates for the framework in accordance with the target-related information, presents, to a user of the information processing apparatus, the one or more candidates provided in response to the input of the prompt into a trained language model, and determines a candidate for the framework selected by the user from among the presented candidates for the framework as the framework in accordance with the target-related information.

### (Supplementary Note C5)

The thinking support program according to Supplementary note C2, wherein the presentation means presents the framework with the content inputted in a presentation mode that is in accordance with an attribute of a subject to whom the framework is presented.

### (Supplementary Note C6)

The thinking support program according to any one of Supplementary notes C1 to C5, wherein the generation control means generates, using the target-related information, a prompt for instructing the generative model to generate content, and inputs the prompt into the generative model, to cause the generative model to generate the content.

### [Additional Remark D]

### (Supplementary Note D1)

An information processing apparatus including at least one processor, the at least one processor carrying out: a reception process of receiving an input of target-related information related to a target of thinking; and a generation control process of causing a generative model trained by performing machine learning to generate, using the target-related information, content to be inputted into a framework capable of being used in thinking about the target.

Here, the information processing apparatus may further include a memory. Further, the memory may store a thinking support program for causing the at least one processor to carry out each of the processes.

### (Supplementary Note D2)

The information processing apparatus according to Supplementary note D1, wherein the at least one processor carries out a presentation process of presenting the framework with the generated content inputted.

### (Supplementary Note D3)

The information processing apparatus according to Supplementary note D1 or D2, wherein the at least one processor carries out a framework determination process of determining the framework in accordance with the target-related information, and in the generation control process, the at least one processor causes the generative model to generate content to be inputted into the framework determined in the framework determination process.

### (Supplementary Note D4)

The information processing apparatus according to Supplementary note D3, wherein in the framework determination process, the at least one processor generates a prompt for instructing to provide one or more candidates for the framework in accordance with the target-related information, presents, to a user of the information processing apparatus, the one or more candidates provided in response to the input of the prompt into a trained language model, and determines a candidate for the framework selected by the user from among the presented candidates for the framework as the framework in accordance with the target-related information.

### (Supplementary Note D5)

The information processing apparatus according to Supplementary note D2, wherein in the presentation process, the at least one processor presents the framework with the content inputted in a presentation mode that is in accordance with an attribute of a subject to whom the framework is presented.

### (Supplementary Note D6)

The information processing apparatus according to any one of Supplementary notes D1 to D5, wherein in the generation control process, the at least one processor generates, using the target-related information, a prompt for instructing the generative model to generate content, and inputs the prompt into the generative model, to cause the generative model to generate the content.

### [Additional Remark E]

### (Supplementary Note E1)

A non-transitory storage medium storing a thinking support program causing a computer to carry out: a reception process of receiving an input of target-related information related to a target of thinking; and a generation control process of causing a generative model trained by performing machine learning to generate, using the target-related information, content to be inputted into a framework capable of being used in thinking about the target.

### REFERENCE SIGNS LIST

1 Information processing apparatus
11 Reception section (reception means)
12 Generation control section (generation control means)
2 Information processing apparatus
201 Reception section (reception means)
202 Framework determination section (framework determination means)
203 Generation control section (generation control means)
204 Presentation section (presentation means)
3 Generative model

1. An information processing apparatus comprising at least one processor, the at least one processor carrying out:
a reception process of receiving an input of target-related information related to a target of thinking; and
a generation control process of causing a generative model trained by performing machine learning to generate, using the target-related information, content to be inputted into a framework capable of being used in thinking about the target.

2. The information processing apparatus according to claim 1, wherein the at least one processor carries out a presentation process of presenting the framework with the generated content inputted.

3. The information processing apparatus according to claim 1, wherein
the at least one processor carries out a framework determination process of determining the framework in accordance with the target-related information, and
in the generation control process, the at least one processor causes the generative model to generate content to be inputted into the framework determined in the framework determination process.

4. The information processing apparatus according to claim 3, wherein in the framework determination process, the at least one processor generates a prompt for instructing to provide one or more candidates for the framework in accordance with the target-related information, presents, to a user of the information processing apparatus, the one or more candidates provided in response to the input of the prompt into a trained language model, and determines a candidate for the framework selected by the user from among the presented candidates for the framework as the framework in accordance with the target-related information.

5. The information processing apparatus according to claim 2, wherein in the presentation process, the at least one processor presents the framework with the content inputted in a presentation mode that is in accordance with an attribute of a subject to whom the framework is presented.

6. The information processing apparatus according to claim 1, wherein in the generation control process, the at least one processor generates, using the target-related information, a prompt for instructing the generative model to generate content, and inputs the prompt into the generative model, to cause the generative model to generate the content.

7. A thinking support method comprising:
a reception process of receiving an input of target-related information related to a target of thinking, the process being carried out by at least one processor; and
a generation control process of causing a generative model trained by performing machine learning to generate, using the target-related information, content to be inputted into a framework capable of being used in thinking about the target, the process being carried out by the at least one processor.

8. A computer-readable, non-transitory storage medium storing a thinking support program for causing a computer to function as:
a reception section that receives an input of target-related information related to a target of thinking; and
a generation control section that causes a generative model trained by performing machine learning to generate, using the target-related information, content to be inputted into a framework capable of being used in thinking about the target.
